(19) United States
(12) Patent Application Publication
(10) Pub. No.: US 2018/0238433 A1
(43) Pub. Date: Aug. 23, 2018

(54) METHOD AND SYSTEM FOR MONITORING A SERVICE LIFE OF LUBRICANT APPLIED TO VEHICLE COMPONENTS

(71) Applicant: GM GLOBAL TECHNOLOGY OPERATIONS LLC, Detroit, MI (US)

(72) Inventors: Justin Syrowik, Holly, MI (US); David P. Schankin, Harrison Township, MI (US); Scott J. Benscoter, Metamora, MI (US)

(21) Appl. No.: 15/439,431

(22) Filed: Feb. 22, 2017

(51) Int. Cl. F16H 57/04; B60R 17/02; F01M 11/10

(52) U.S. Cl. CPC F16H 57/0405; B60R 17/02; F01M 2011/1433; F01M 2011/1426; F01M 11/10

(57) ABSTRACT

A system and method for monitoring a service life of lubricant that is applied to vehicle components is disclosed. The method includes receiving at least one input parameter. The input parameter relates to the vehicle's operation. The method also includes determining a remaining service life of a lubricant. The lubricant is applied to a driveline component of the vehicle. The determination of the remaining service life of the lubricant is based on the receiving of at least one input parameter.

The subject embodiments relate to monitoring a service life of a lubricant that is applied to vehicle components. Specifically, one or more embodiments can be directed to monitoring a service life of a lubricant that is applied to driveline components of a vehicle, for example.

Within a motor vehicle, a powertrain generally refers to a system of vehicle components that produce power and that transfer the produced power to a road surface. A driveline of the powertrain generally refers to a portion of the powertrain that excludes an engine and a transmission of the powertrain. For example, a driveline can include components such as a drive unit, a rear-drive module, a transfer case, an axle, and/or other torque-transfer devices, for example.

A lubricating agent is supplied within the inside of different driveline components. For example, a lubricant is supplied within an axle. With certain trucks, axle lubricant is filled within the housing of a rear beam axle, for example. The rear beam axle of the truck is the component that houses a differential and/or a gear set, for example. The axle lubricant can be provided inside this rear axle, and the axle lubricant can splash around the inside of the axle as the vehicle travels.

### SUMMARY

In one exemplary embodiment, a method includes receiving, by an electronic control unit of a vehicle, at least one input parameter. The input parameter relates to the vehicle's operation. The method also includes determining a remaining service life of a lubricant. The lubricant is applied to a driveline component of the vehicle. The determining the remaining service life of the lubricant is based on the receiving of at least one input.

In another exemplary embodiment, the method includes providing an indication that the lubricant should be replaced. The indication is provided based on the determining.

In another exemplary embodiment, the driveline component includes one of a drive unit, a rear-drive module, a transfer case, an axle, and a torque-transfer device.

In another exemplary embodiment, the determining includes determining the remaining service life based on an amount of accumulated energy that has been transferred through the driveline component.

In another exemplary embodiment, the accumulated energy is determined based on a transmission output torque and a wheel speed.

In another exemplary embodiment, at least one input parameter corresponds to at least one of a distance travelled, a transmission output torque, a determination of whether a spare tire is being used, a mileage, a determination of whether a limited slip differential is being used, an age of the lubricant, and a speed of driven wheels.

In another exemplary embodiment, the determining the remaining service life of the lubricant includes determining a remaining life of an additive within the lubricant.

In another exemplary embodiment, the additive includes a friction modifier additive.

In another exemplary embodiment, providing the indication that the lubricant should be replaced includes providing the indication via an indicator light.

In another exemplary embodiment, the method also includes providing an indication of the amount of remaining service life of the lubricant.

In another exemplary embodiment, a system within a vehicle includes an electronic control unit. The electronic control unit is configured to receive at least one input parameter. The input parameter relates to the vehicle's operation. The electronic control unit is also configured to determine a remaining service life of a lubricant. The lubricant is applied to a driveline component of the vehicle. The determining the remaining service life of the lubricant is based on the received at least one input.

In another exemplary embodiment, the electronic control unit is further configured to provide an indication that the lubricant should be replaced. The indication is provided based on the determining.

In another exemplary embodiment, the driveline component includes one of a drive unit, a rear-drive module, a transfer case, an axle, and a torque-transfer device.

In another exemplary embodiment, the determining includes determining the remaining service life based on an amount of accumulated energy that has been transferred through the driveline component.

In another exemplary embodiment, the accumulated energy is determined based on a transmission output torque and a wheel speed.

In another exemplary embodiment, the at least one input parameter corresponds to at least one of a distance travelled, a transmission output torque, a determination of whether a spare tire is being used, a mileage, a determination of whether a limited slip differential is being used, an age of the lubricant, and a speed of driven wheels.

In another exemplary embodiment, the determining the remaining service life of the lubricant includes determining a remaining life of an additive within the lubricant.

In another exemplary embodiment, the additive includes a friction modifier additive.

In another exemplary embodiment, providing the indication that the lubricant should be replaced includes providing the indication via an indicator light.

In another exemplary embodiment, the electronic control unit is further configured to provide an indication of the amount of remaining service life of the lubricant.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a configuration of a system that monitors a service life of an applied lubricant, in accordance with one or more embodiments;

FIG. 2 depicts a terminal for monitoring a service life of an applied lubricant, in accordance with one or more embodiments;

FIG. 3 depicts a flowchart of a method in accordance with one or more embodiments; and

FIG. 4 depicts a high-level block diagram of a computing system, which can be used to implement one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment, a vehicle system can be configured to actively determine/monitor a service life of a driveline lubricant, and thus embodiments can inform the vehicle owner of when the driveline lubricant should be replaced, based upon actual usage of the vehicle.

Embodiments can be directed to determining a service life of a lubricant, where the lubricant is applied to any one of a drive unit, a rear-drive module, a transfer case, an axle, and a torque-transfer device. Although axle lubricants are specifically described below with respect to certain embodiments, other embodiments can be directed to monitoring service life of lubricants that are applied to drive units, rear drive modules, transfer cases, and/or other torque-transfer devices.

Embodiments can inform a user (such as a vehicle owner) when it is time to replace the vehicle lubricant that is applied to the driveline, based on an accumulated mileage and/or based upon an energy accumulation basis, as described in more detail below. An accumulated mileage can refer to the amount of mileage that has accumulated in the time that has elapsed since the lubricant was applied. An energy accumulation can refer to the accumulated amount of energy that has been transferred through and/or expended through a component to which the lubricant has been applied, in the time that has elapsed since the lubricant was applied to the component.

With previous approaches, a vehicle manufacturer typically supplied each manufactured vehicle with a surplus of driveline lubricant. For example, for driveline axles, the vehicle manufacturer typically supplied each axle with a surplus of lubricant. The amount of supplied lubricant within the driveline can be an amount that is sufficient to support both a “normal” and a “severe” vehicular usage, for the entire working life of the vehicle. A vehicle that has been supplied with sufficient lubricant to support usage throughout the entire working life of the vehicle is considered to be “filled for life,” but the lubricant is still typically replaced according to a pre-set schedule under severe usage.

Because one or more embodiments can monitor the service life of the lubricant, vehicle manufacturers no longer have to add a surplus of lubricant that is intended to last the entire working life of the vehicle. Rather, vehicle manufacturers can be more precise in the amount of lubricant that they apply to drivelines. As such, with certain embodiments, vehicle manufacturers can possibly improve the fuel efficiency of their vehicles, while also possibly reducing financial costs and environmental costs. In addition, the customer has peace of mind that the lubricant replacement schedule is tailored to their individual vehicle usage.

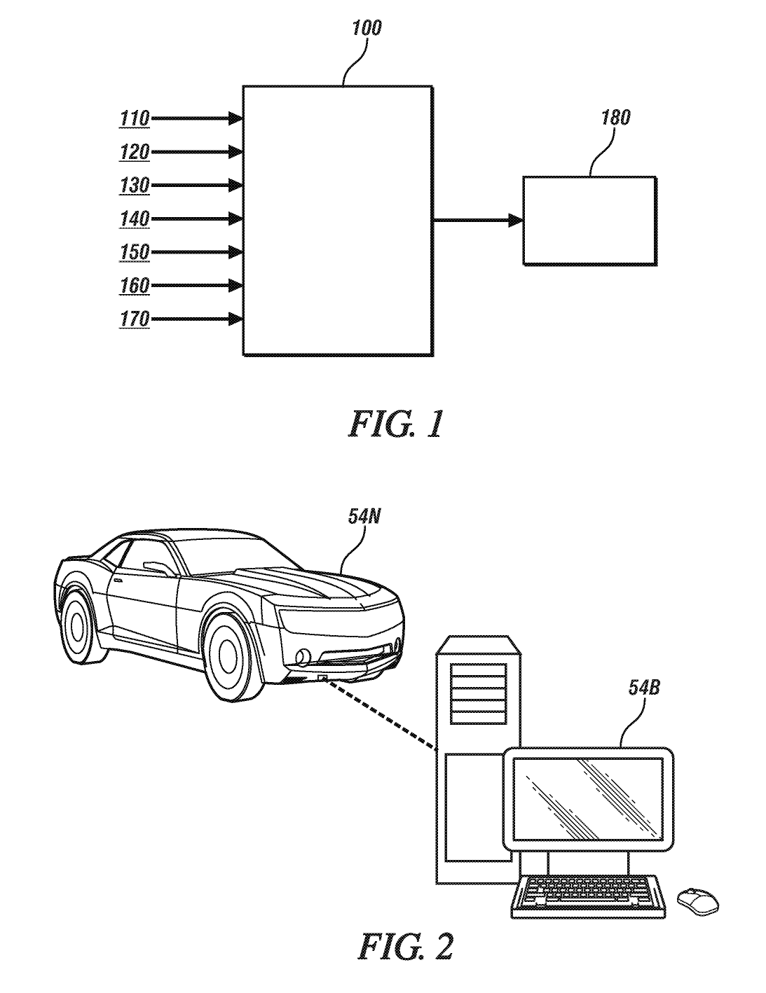

FIG. 1 depicts a configuration of a system 100 that monitors a service life of an applied lubricant, in accordance with one or more embodiments. In the example of FIG. 1, the example applied lubricant is an axle lubricant. However, other embodiments can monitor other types of lubricants that are applied to other types of driveline components. In order to determine the service life of the axle lubricant of FIG. 1, and in order to determine whether the axle lubricant should be replaced, system 100 can receive and process one or more input parameters (110-170).

Referring to FIG. 1, one of the input parameters that can be used for determining the service life of the lubricant can be an input that indicates a distance traveled 110. The distance travelled can correspond to the distance that has been travelled since the time that the lubricant was applied. When determining the service life of the lubricant based upon the distance travelled, the distance travelled can be inversely related to the length of remaining service life of the lubricant. That is, a larger distance that has been travelled by the vehicle can correspond to a shorter remaining service life of the applied lubricant.

Another input parameter that can be used for determining the service life of the lubricant can be a measurement of transmission output torque 120. Embodiments can use a measurement of transmission output torque in order to determine an amount of energy that has been transferred through and/or expended through the axle. Specifically, an amount of power that is being transferred through and/or expended by the axle can be calculated based upon the transmission output torque (i.e., the measured torque that is supplied by the axle) and a speed of the axle. After determining an amount of energy that has been transferred through the axle (since the time the lubricant was applied to the axle), embodiments can make a determination regarding the remaining service life of the applied lubricant. When making this determination, the amount of accumulated energy can be inversely related to the length of the remaining service life of the applied lubricant. That is, the greater the amount of power that has been transferred through the axle, the shorter the remaining service life of the applied lubricant upon the axle. Embodiments can also consider a power measurement (i.e., a rate of doing work) for the axle upon which the lubricant is applied, where a higher operating power tends to shorten the service life of the lubricant.

Another input parameter that can be used for determining the remaining service life of the lubricant can be a determination 130 regarding whether a spare tire is mounted as a wheel. Use of a mounted spare tire will tend to more quickly shorten the service life of the lubricant.

Another input parameter that can be used for determining the service life of the lubricant can be a measurement 140 of mileage since the last lubricant change. When determining the remaining service life of the lubricant based upon the mileage since the last lubricant change, a larger mileage value can result in a shorter remaining service life of the applied lubricant.

Another input parameter that can be used for determining the service life of the lubricant can be a determination 150 regarding whether a limited-slip differential is presently used by the vehicle. In the event that a limited-slip differential is being presently used, embodiments may then also consider whether an additive within the lubricant has reached the end of the additive's usable life.

Lubricants can include additives that improve vehicle performance. One example additive is a friction modifier additive, which can be particularly important in maintaining consistent vehicle performance in limited-slip differentials, for example. However, the service life of the friction modifier additive (and thus the service life of the lubricant in which the additive is contained) is expended over time when the vehicle is used.

In view of the above, if a limited slip differential is presently used within the vehicle, embodiments can determine the service life of additives within the lubricant. If an additive within the lubricant has reached the end of its service life, then embodiments can also determine that the lubricant itself (within which the additive is contained) has also reached the end of the lubricant's service life.

Another input parameter that can be used for determining the service life of the lubricant can be a measurement of an age 160 of the lubricant. When determining the service life of the lubricant based upon the age of a lubricant, the higher the age of the lubricant, the shorter the remaining service life of the applied lubricant.

Another input parameter that can be used for determining the service life of the lubricant can be a measurement 170 of speed of driven wheels. As described above, a measurement of wheel speed can be used in conjunction with a measurement of output torque in order to determine an amount of energy that is being expended and/or transferred through the axle.

Although FIG. 1 has listed a plurality of example inputs, other embodiments can use other possible inputs. Other embodiments can use more or fewer input parameters. Upon determining the service life of the lubricant using one or more inputs, if the remaining service life of the lubricant has reached a certain low-end threshold, such that the lubricant should be replaced, embodiments can then provide an indication 180 to the vehicle owner. Indication 180 can be a visual or audible indicator that the lubricant should be replaced. For example, the indication can be an indicator light that illuminates when the lubricant should be replaced. The indication can be presented within a driver information interface, for example. In addition to providing an indication that indicates that replacement should occur, embodiments can also provide an indication that depicts the remaining lubricant service life. The remaining lubricant service life can be expressed as a percentage of the original full lifespan. In one example embodiment, the indication 180 can vary in accordance with the remaining lubricant service life. The indication 180 can provide different messages that correspond to different amounts of remaining service life. For example, when the remaining lubricant service life is within the range of 10% to 100% of the original full lifespan, the indication 180 can reflect that no action is needed. When the remaining lubricant service life reaches 10% of the original full lifespan, then the indication 180 can communicate a message such as, for example, “replace axle lube soon.” When the remaining lubricant service life reaches 0% of the original full lifespan, then the indication 180 can communicate a message such as, for example, “axle lube replacement required.” When the vehicle is used beyond the full lifespan of the lubricant, such that the determined remaining lubricant service life is −5% of the original full lifespan, then the indication 180 can communicate a message such as, for example, “continued operation without axle lube replacement may result in damage to axle.”

One or more of the example inputs 110-170 of FIG. 1 can be measurements/determinations that correspond to signals that are utilized by an embedded system within the vehicle. Vehicles can include one or more embedded systems that control one or more electrical systems within the vehicles. An electrical system within the vehicle can include one or more electronic control units (ECUs) that transmit and receive signals that correspond to different measurements, for example. Each of the different measurements can be measurements that correspond to vehicle operations.

One or more embodiments can use signals and measurements that are transmitted by ECUs to determine a service life of the axle lubricant, and to determine when the axle lubricant should be replaced. For example, embodiments can use the signals and measurements derived from the ECU network to determine a tailored lubricant replacement plan for the vehicle owner. With one or more embodiments, a vehicle owner can be made aware of the service life of the axle lubricant, at any point in time.

Embodiments can also implement additional sensors within the vehicle, in order to measure additional measurements, where these additional measurements can be used to determine the service life of the lubricant. For example, certain embodiments may implement a temperature sensor (at the driveline component) to measure the temperature of the driveline component. Operating at higher temperatures will tend to shorten the service life of the lubricant.

FIG. 2 depicts a terminal for monitoring a service life of an applied lubricant, in accordance with one or more embodiments. As described above, one or more embodiments can allow a vehicle owner to actively monitor the service life of the driveline lubricants. For example, indicators regarding the remaining service life of the lubricants can appear on the dashboard of the vehicle for example. One or more embodiments can also enable a vehicle professional (such as a car mechanic, for example) to perform diagnostics on the condition of the driveline lubricants. Referring to the example system of FIG. 2, a car mechanic can use a terminal 54B to perform advanced diagnostics and/or advanced monitoring of the condition of the driveline lubricants of vehicle 54N. The diagnostic information shown on terminal 54B can possibly be more detailed than the information provided via the indicators within vehicle 54N, for example.

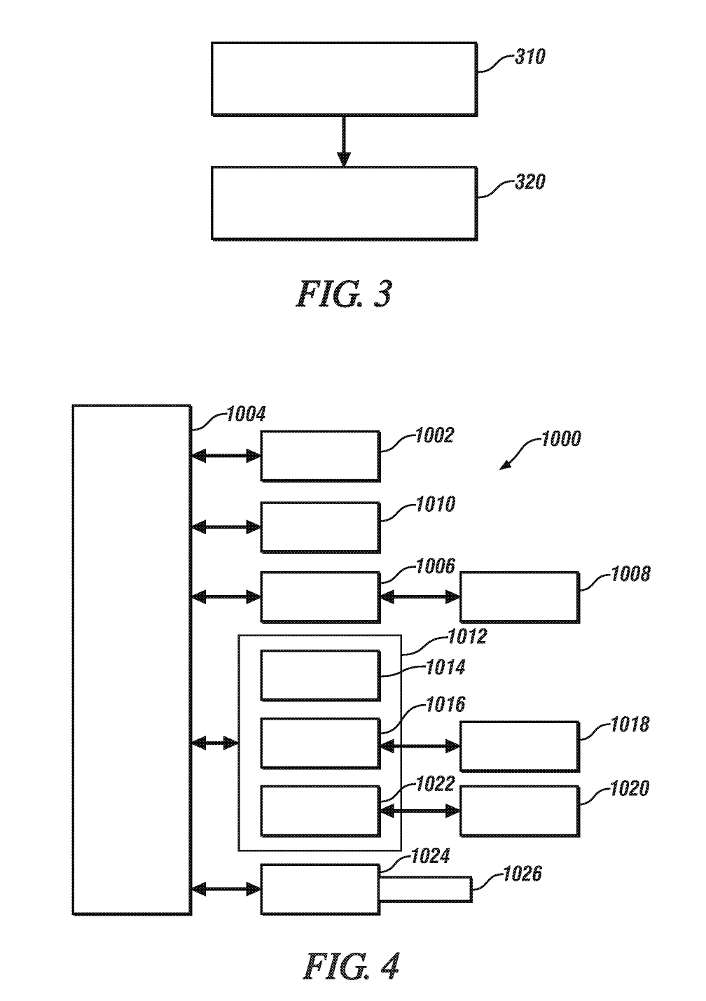

FIG. 3 depicts a flowchart of a method in accordance with one or more embodiments. The method includes, at block 310, receiving, by an electronic control unit of a vehicle, at least one input parameter. The input parameter relates to the vehicle's operation. The method includes, at block 320, determining a remaining service life of a lubricant. The lubricant is applied to a driveline component of the vehicle. The determining the remaining service life of the lubricant is based on the received at least one input.

FIG. 4 depicts a high-level block diagram of a computing system 1000, which can be used to implement one or more embodiments. Computing system 1000 can correspond to, at least, an electronic processing device that can receive and process the inputs that are depicted in FIG. 1, for example. The electronic processing device can be a part of an embedded system of electronics within a vehicle. With one or more embodiments, computing system 1000 can correspond to an ECU of a vehicle. Computing system 1000 can be used to implement hardware components of systems capable of performing methods described herein. Although one exemplary computing system 1000 is shown, computing system 1000 includes a communication path 1026, which connects computing system 1000 to additional systems (not depicted). Computing system 1000 and additional system are in communication via communication path 1026, e.g., to communicate data between them.

Computing system 1000 includes one or more processors, such as processor 1002. Processor 1002 is connected to a communication infrastructure 1004 (e.g., a communications bus, cross-over bar, or network). Computing system 1000 can include a display interface 1006 that forwards graphics, textual content, and other data from communication infrastructure 1004 (or from a frame buffer not shown) for display on a display unit 1008. Display unit 1008 can correspond to at least a portion of a dashboard of a vehicle, for example. Computing system 1000 also includes a main memory 1010, preferably random access memory (RAM), and can also include a secondary memory 1012. There also can be one or more disk drives 1014 contained within secondary memory 1012. Removable storage drive 1016 reads from and/or writes to a removable storage unit 1018. As will be appreciated, removable storage unit 1018 includes a computer-readable medium having stored therein computer software and/or data.

In alternative embodiments, secondary memory 1012 can include other similar means for allowing computer programs or other instructions to be loaded into the computing system. Such means can include, for example, a removable storage unit 1020 and an interface 1022.

In the present description, the terms “computer program medium,” “computer usable medium,” and “computer-readable medium” are used to refer to media such as main memory 1010 and secondary memory 1012, removable storage drive 1016, and a disk installed in disk drive 1014. Computer programs (also called computer control logic) are stored in main memory 1010 and/or secondary memory 1012. Computer programs also can be received via communications interface 1024. Such computer programs, when run, enable the computing system to perform the features discussed herein. In particular, the computer programs, when run, enable processor 1002 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method, the method comprising:
receiving, by an electronic control unit of a vehicle, at least one input parameter, wherein the input parameter relates to the vehicle's operation; and
determining a remaining service life of a lubricant, wherein the lubricant is applied to a driveline component of the vehicle, and the determining the remaining service life of the lubricant is based on the received at least one input parameter.

2. The method of claim 1, further comprising:
providing an indication that the lubricant should be replaced, wherein the indication is provided based on the determining.

3. The method of claim 1, wherein the driveline component comprises one of a drive unit, a rear-drive module, a transfer case, an axle, and a torque-transfer device.

4. The method of claim 1, wherein the determining comprises determining the remaining service life based on an amount of accumulated energy that has been transferred through the driveline component.

5. The method of claim 4, wherein the accumulated energy is determined based on a transmission output torque and a wheel speed.

6. The method of claim 1, wherein the at least one input parameter corresponds to at least one of a distance travelled, a transmission output torque, a determination of whether a spare tire is being used, a mileage, a determination of whether a limited slip differential is being used, an age of the lubricant, and a speed of driven wheels.

7. The method of claim 1, wherein the determining the remaining service life of the lubricant comprises determining a remaining life of an additive within the lubricant.

8. The method of claim 7, wherein the additive comprises a friction modifier additive.

9. The method of claim 2, wherein providing the indication that the lubricant should be replaced comprises providing the indication via an indicator light.

10. The method of claim 1, further comprising providing an indication of the amount of remaining service life of the lubricant.

11. A system within a vehicle, comprising:
an electronic control unit configured to:
receive at least one input parameter, wherein the input parameter relates to the vehicle's operation; and
determine a remaining service life of a lubricant, wherein the lubricant is applied to a driveline component of the vehicle, and the determining the remaining service life of the lubricant is based on the received at least one input parameter.

12. The system of claim 11, wherein the electronic control unit is further configured to provide an indication that the lubricant should be replaced, wherein the indication is provided based on the determining.

13. The system of claim 11, wherein the driveline component comprises one of a drive unit, a rear-drive module, a transfer case, an axle, and a torque-transfer device.

14. The system of claim 11, wherein the determining comprises determining the remaining service life based on an amount of accumulated energy that has been transferred through the driveline component.

15. The system of claim 14, wherein the accumulated energy is determined based on a transmission output torque and a wheel speed.

16. The system of claim 11, wherein the at least one input parameter corresponds to at least one of a distance travelled, a transmission output torque, a determination of whether a spare tire is being used, a mileage, a determination of whether a limited slip differential is being used, an age of the lubricant, and a speed of driven wheels.

17. The system of claim 11, wherein the determining the remaining service life of the lubricant comprises determining a remaining life of an additive within the lubricant.

18. The system of claim 17, wherein the additive comprises a friction modifier additive.

19. The system of claim 12, wherein providing the indication that the lubricant should be replaced comprises providing the indication via an indicator light.

20. The system of claim 11, wherein the electronic control unit is further configured to provide an indication of the amount of remaining service life of the lubricant.
